(19) United States
(12) Patent Application Publication
(10) Pub. No.: US 2010/0139835 A1
(43) Pub. Date: Jun. 10, 2010

(54) METHOD AND SYSTEM OF FABRICATING FACADE PANELS

(76) Inventor: Harry Giles, Ann Arbor, MI (US)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/635,407

(22) Filed: Dec. 10, 2009

Related U.S. Application Data
(60) Provisional application No. 61/121,431, filed on Dec. 10, 2008.

(51) Int. Cl. B29C 65/52; B29C 65/78

(52) U.S. Cl. 156/60; 156/350

(57) ABSTRACT

A method and system of manufacturing multi-layered composite panels is disclosed wherein various geometrically configured inner core elements are attached along the core's edges to outer sheets of light-transmitting material using guided computer numerical control. The guided computer numerical control is used to apply adhesives and to direct adhesive cure devices, continuously or in parts, between the core and the skin to achieve an energy-efficient, structurally-enhanced integral light-transmitting façade panel.

### BACKGROUND

This patent is directed to a method and a system of fabricating façade panels, and, in particular, to a method and a system of fabricating façade panels made from polymer, glass, synthetic fiber-reinforced composite and organic fiber-reinforced composite materials and various combinations thereof.

As part of a growing awareness of environmental issues, it has been documented that buildings (commercial and residential) account for about 40% of the energy consumption in the United States. Moreover, when buildings are demolished, they account for 24% of landfill wastes. Furthermore, the construction industry is a growing consumer of non-renewable materials, a trend that has escalated dramatically over the past century.

As to the issue of energy consumption, consideration has been given to the use of synthetic materials with advanced structures. For example, U.S. Patent Publ. No. 2005/0136198 illustrates an architectural insulating glass unit with an open cell polycarbonate insert disposed between two glass facings within a metal perimeter spacer or frame. Similarly, U.S. Pat. No. 6,105,318 illustrates a window frame that supports angled louvers between panes of insulating glass, which louvers are designed with seasonal variations of sunlight in mind. Of course, as noted in U.S. Pat. No. 6,500,516, where the intent of the unit is to provide a visually uniform, light-transmitting sheet, much like a conventional translucent and transparent façade elements, many fabrication techniques produce defects that inhibit clear transparency and as such reduce the desirability of the panels in the architectural and design fields.

At the same time, others have considered advanced structures utilizing polymer and composite materials and various combinations thereof to address not only the energy consumption issue, but also landfill and renewable material issues with enhanced structural performance characteristics. In particular, façade elements have been designed that utilize a core between transparent or translucent facings, wherein the insert is fabricated using renewable and/or recyclable materials. Harry Giles, SITumbra—Energy Efficient Structurally Integrated Transparent Shaded Façade System, Clean Technology and Sustainable Industries Conference (Boston, Mass., USA—2008). These panels are designed to have different performance characteristics relative to seasonal sunlight changes. In addition, the configuration of the combined core and multi-layered sheet integral composite structural behavior provides enhanced structural performance characteristics over conventional window systems, while maintaining visual transparency and providing enhanced energy efficiency characteristics.

### SUMMARY

According to one aspect of the disclosure, a method for fabricating a façade element includes disposing a core on a worktable, the core having a first edge and a second edge opposite the first edge, the second edge being disposed on the worktable. The method also includes applying an adhesive to the first edge of the core using guided computer numerical control, applying a first sheet of light-transmitting material to the first edge of the core, curing the adhesive along the first edge of the core using guided computer numerical control to secure the core to the first sheet to define a partial assembly, and disposing the partial assembly on the worktable with the first sheet disposed on worktable. The method further includes applying an adhesive to the second edge of the core using guided computer numerical control, applying a second sheet of light-transmitting material to the second edge of the core, and curing the adhesive along the second edge of the core using guided computer numerical control to secure the core to the second sheet to define a completed assembly.

According to another aspect of the disclosure, a system for fabricating a façade element includes a worktable, a tool holder mounted on a first carrier, the first carrier mounted on a second carrier, and the second carrier mounted on rails that run along a length of the worktable. The first carrier is moveable relative to the second carrier in a first direction, the second carrier is moveable relative to the worktable in a second direction orthogonal to the first direction, and the tool holder is moveable in a third direction orthogonal to the first and second directions. An adhesive dispenser is attached to the tool holder, and a curing device is attached to the tool holder. A controller is programmed to control the tool holder, first carrier, second carrier and the adhesive dispenser to apply an adhesive to a first edge of a core, the core disposed on the worktable and having a second edge opposite the first edge, to control the tool holder, first carrier, second carrier and the curing device to cure the adhesive along the first edge of the core through a first sheet of light-transmitting material applied to the first edge of the core using guided computer numerical control to secure the core to the first sheet to define a partial assembly, to control the tool holder, first carrier, second carrier and the adhesive dispenser to apply an adhesive to the second edge of the core using guided computer numerical control, and to control the tool holder, first carrier, second carrier and the curing device to cure the adhesive along the second edge of the core through a second sheet of light-transmitting material applied to the second edge of the core using guided computer numerical control to secure the core to the second sheet to define a completed assembly.

### BRIEF DESCRIPTION OF THE DRAWINGS

FIG. 1 is an exploded view of a façade element according to the present disclosure;

FIG. 2 is a perspective view of a variety of cores that may be used in the façade element according to the present disclosure;

FIG. 3 is a schematic view of a system used to fabricate the façade element of FIG. 1; and

FIG. 4 is a flowchart illustrating a method used to fabricate the façade element of FIG. 1 utilizing the system of FIG. 3.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

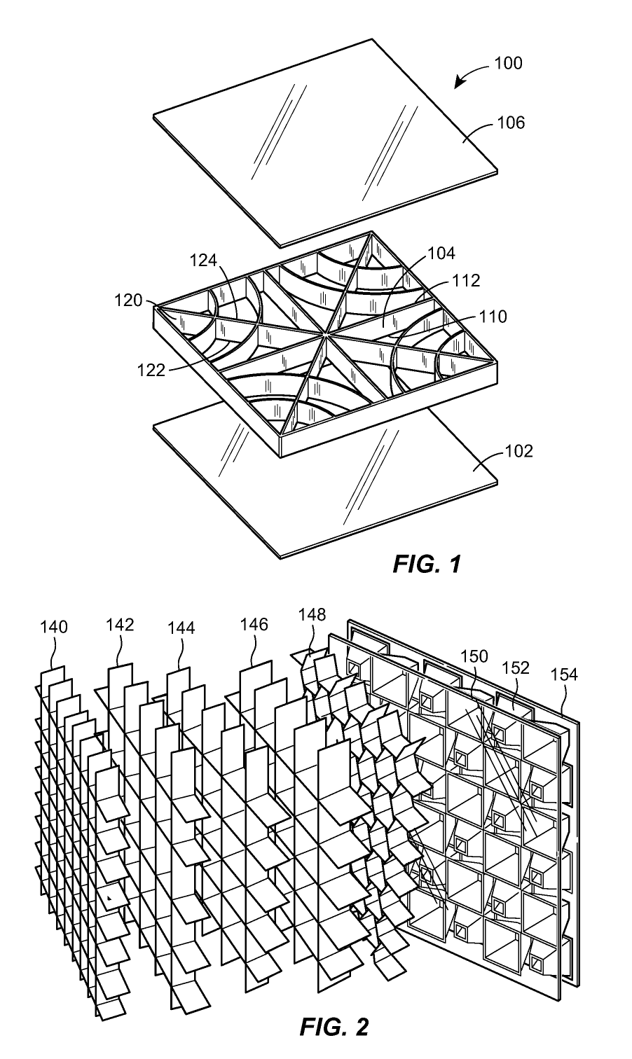

FIG. 1 illustrates a façade element 100 according to the present disclosure, such as may be used in a wall, for example. The façade element 100 includes a first sheet 102 of a light-transmitting material, a core 104 and a second sheet 106 of a light-transmitting material. As assembled, the first sheet 102 is attached to an edge 110 of the core 104, while the second sheet 106 is attached to an opposing edge 112 of the core 104. Although the illustrated element 100 has a generally planar profile, the element 100 may also have a curved profile, in whole or in part.

While it is not required, the first and second sheets 102, 106 may be made of the same light-transmitting material. According to certain embodiments, the light-transmitting material is transparent. Such embodiments are particularly desirable for use as façade elements, permitting persons standing on one side of the element 100 to see through to the other side of the element 100. However, it is also within the scope of the present disclosure for the sheets 102, 106 to be translucent or even opaque over a portion of the sheet. While glass may be used, it is also possible to use typical light-transmitting plastics (acrylic, polycarbonate, polypropylene, or polyethylene terephthalate (PET) and/or laminations of acrylic/polycarbonate, acrylic/glass, polycarbonate/glass, etc. where each of the sheets may include a plurality of thin sheets of one or another of the materials that are laminated together) and other polymers, as well as fiber composites that may include synthetic and/or organic fibers. Furthermore, it is also possible to use glass that has been fused together with one or more polymer sheets, or that is colored or tinted or has a coating applied thereto to alter the light-transmitting characteristics of the glass or plastic or to improve its resistance to damage (e.g., scratches, ultraviolet radiation degradation, flammability, etc.), for example.

As seen in FIG. 1, the core 104 may be designed using a number of thin-walled subelements 120, each subelement 120 having an edge 122 that defines the edge 110 of the core 104, and an edge 124 that defines the edge 112 of the core 104. These subelements 120 may be arranged in a variety of configurations or patterns, certain of which are illustrated in FIG. 2. For example, the subelements 120 may define an open-celled (i.e., having a passage from one edge to the other) grid pattern 140, 142, 144, 146, wherein the individual cells may vary in size from one pattern 140, 142, 144, 146 to the next and may vary as to other characteristics from one pattern to the next (e.g., core 142 may be white and core 144 may be black). Alternatively, the subelements 120 may be assembled into open-celled, hex-shaped patterns 148; these hex-shaped patterns 148 may not be regular (i.e., have equal side lengths) such that nesting of the hex-shaped patterns 148 may define additional open cells between the hex-shaped patterns 148. As a still further example, the subelements 120 may be assembled into pyramid-shaped patterns 150, which patterns 150 may be disposed between the sheets 152, 154 such that the patterns 150 alternate orientation relative to the sheets 152, 154. Still other shapes are possible for the cells of the core 104, such as triangles, rectangles, trapezoids, diamonds, pentagons and other faceted shapes, as well as curves shapes, such as a circles and ellipses, and combinations thereof.

The shapes (triangular, rectangular, etc.) need not be of regular shape (e.g., an equilateral triangle) or in a regular array or pattern, and may be uniquely disposed, for example, as shown FIG. 1. Moreover, the shapes may be parametrically varying shapes across the panel or randomly arranged cells, and may even include customized arrangements set up for each manufacturing operation. Customized manufacturing is particularly assisted by the guided computer numerical control methods described below, and may permit the use of random variations such as parametric fractal- and voronoi-generated geometries.

A variety of materials may be used for the core 104, and in particular the subelements 120 of the core 104. For example, the core 104 may be made of a plastic or other polymer, or a composite material made using synthetic and/or organic fibers. For example, the core 104 may be made of polycarbonate. According to certain other embodiments, the core 104 may be made of a variety of other transparent materials such as acrylic, glass, polypropylene, polyethylene terephthalate (PET) and similar such materials. The material chosen may itself be light-transmitting or translucent, if not transparent. For example, the core 104 (and in particular the subelements 120) may be made of a tinted or colored plastic material. Alternatively, the subelements 120 may be completely opaque. The cores may also be made of certain light-transmitting subelements and certain opaque subelements.

In certain applications, the material selected for use in the core 104 may minimize the landfill contribution of the façade element 100 after the element 100 has served its usefulness as a structural element. For example, the material used for the core 104 may be recyclable, as may be the material used for the sheets 102, 106. That is, certain polymers may be recovered after the façade element is removed during demolition of the structure it defined. In particular, the sheets 102, 106 may be stripped from the core 104 during recovery, and the sheets 102, 106 and/or the core 104 may be recycled or disposed of separately if made from different materials. For example, the core 104 may be made of a material that is biodegradable and disposed of to a landfill while the sheets 102, 106 are recycled.

The size and spacing of the subelements 120 may be selected to control solar transmission through the element 100 in addition to providing strength and stiffness to the element 100. For example, the distance between the sheets 102, 106 of the façade element 100 (which may also be referred to in general terms as the thickness of the core 104) may be selected such that light entering the first sheet 102 of the façade element 100 at a first angle is blocked by the core 104 during a particular season (e.g., summer). At the same time, light entering the first sheet 102 of the façade element 100 at a second angle is passes through the core 104 from the first sheet 102 to the second sheet 106, and into the space adjoining the second sheet 106 during a second season (e.g., winter). This second angle may be a smaller angle, relative to the horizontal, permitting transmission through the façade element 100. The particular determination may require consideration of the latitude at which the element 100 will be used, as well as the climatic conditions at that location, the required energy performance, and the compass bearing of the structure in which the element 100 is incorporated (as determined in the place of the element 100, both in the vertical and horizontal directions, for example). After this fashion, the core 104 may be sized to permit passive tempering of solar thermal energy performance of the façade element 100, maximizing beneficial heat gain in the winter and minimizing unwanted heat gain in the summer.

It will be recognized that fabrication of the façade element 100 will require the attachment of the sheets 102, 106 to the core 104. It will also be recognized that attachment of the sheets 102, 106 to the core 104 may be performed by applying an adhesive to the core 104 or the sheets 102, 106, and then placing the sheets 102, 106 in contact with the core 104. However, inaccurate application of adhesive can lead to imperfections in the element 100, leading to a decrease in its desirability as an architectural design unit.

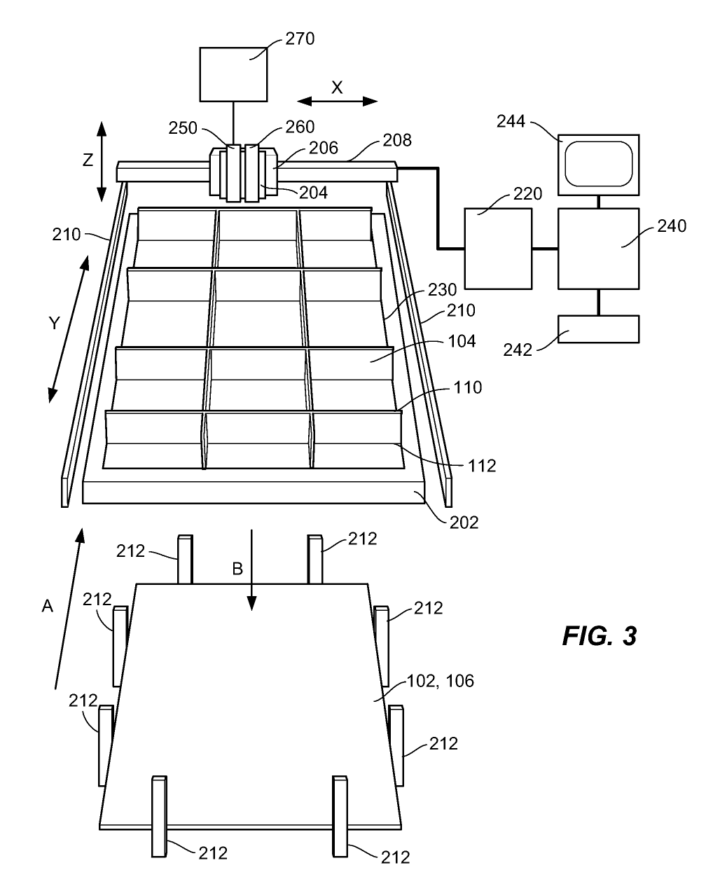

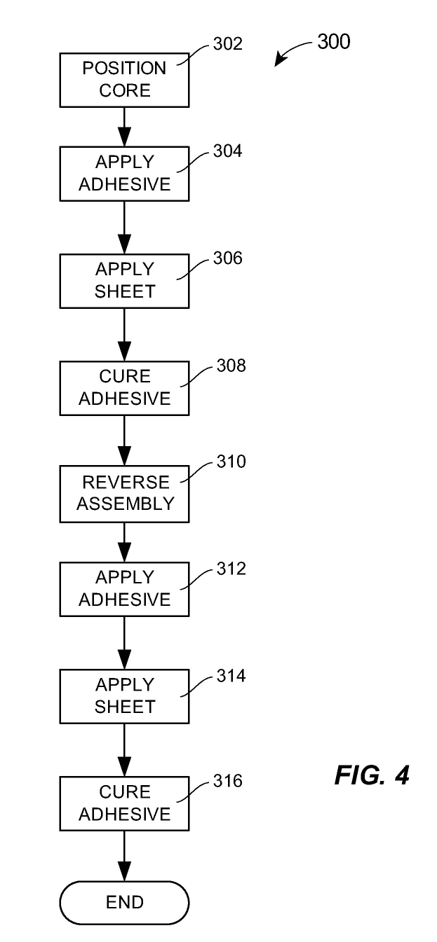

FIG. 3 illustrates a system 200 to fabricate the façade elements 100 in such a fashion as to optimize the accurate formation of adhesive bonds between the sheets 102, 106 and the core 104. The method 300 utilizing this system 200 is illustrated in FIG. 4.

The system 200 includes a worktable 202 and a moveable tool holder 204. As illustrated, the tool holder 204 is selectively moveable relative to the worktable 202 in a first direction indicated by the double-headed arrow X, in a second direction indicated by the double-headed arrow Y and in a third direction indicated by the double-headed arrow Z. In particular, the tool holder 204 is moved using guided computer numerical control.

According to the illustrated embodiment, the movement of the tool holder 204 in the X-direction, in the Y-direction and in the Z-direction is facilitated through the use of two carriers 206, 208. The first carrier 206 is mounted on the second carrier 208 so that the first carrier 206 is moveable relative to the carrier 208 in the direction indicated by the double-headed arrow X. Furthermore, the second carrier 208 is mounted relative to the worktable 202 so as to be moveable relative to the worktable 202 in the direction indicated by the double-headed arrow Y. For example, the second carrier 208 may be mounted on rails 210 that run the length of the worktable 202 in the Y-direction. Finally, the tool holder 204 (which may itself incorporate a carrier) is mounted on the first carrier 206 so as to be moveable relative to the carrier 206 in the direction indicated by the double-headed arrow Z. It will be recognized that this is only one possible system for providing movement of the tool holder 204 in the X-direction, Y-direction, and Z-direction, and that other systems may be substituted therefore (e.g., a robotic arm with articulated motion).

Each of the tool holder 204 and the carriers 206, 208 may be associated with a motor that causes the movement of the tool holder 204 and the carriers 206, 208. In turn, each motor may be associated with a drive that may include such elements as gears, racks, pulleys, belts, etc. as are necessary to convert the rotation of the motor shaft into the lateral movement of the associated holder 204 or carrier 206, 208. Further, the holder 204 and carriers 206, 208 may be associated with sensing mechanisms that provide a signal that may be used in a feedback loop to control the movement of the holder 204 and/or carriers 206, 208.

The tool holder 204 and carriers 206, 208 are coupled to a controller 220, which controls the movement of the tool holder 204 and carriers 206, 208. The controller 220 may provide power to the motors associated with the holder 204 and carriers 206, 208 to move the holder 204 and carriers 206, 208 in discreet increments. The controller 220 is, in turn, controlled by a computing device, or computer, 240 that sends directive signals to the controller 220.

In particular, the controller 220 is programmable to move the tool holder 204 and carriers 206, 208 according to conventional computer numerical control methods and algorithms, such that a tool disposed in the tool holder 204 may be positioned at precise locations relative to the worktable 202. The controller 220 may include a processor, memory (in the form of Read Only Memory (ROM) and Random Access Memory (RAM)), input/output interfaces and a power supply, for example.

The computing device 240 coupled to the controller 220 may also include a processor, memory (in the form of Read Only Memory (ROM) and Random Access Memory (RAM)), input/output interfaces and a power supply, for example. Further, the computing device may be associated with an input device 242, in the form of a keyboard or pointing device (e.g., mouse), and an output device 244, in the form of a monitor or other display device. The computing device 240 transmits control signals to the controller 220 that control the specific movement of the carriers 206, 208 in the X-direction and the Y-direction, respectively, and the tool holder 204 in the Z-direction.

The computing device 240 may also transmit control signals to the controller 220 to control the tool holder 204 to activate a tool associated with the tool holder 204. According to the illustrated embodiment, the tool holder 204 may have two tools associated therewith: a dispensing device (which may also be referred to as a dispenser or an applicator) 250 and a curing device 260. It will be recognized that the tool holder 204 may have only one tool or part thereof mounted thereon at a time, but it has been found that certain advantages are realized when multiple tools or parts thereof are attached to the tool holder 204. For that matter, according to other embodiments, the tool holder 204 may have more than two tools associated therewith.

The dispensing device 250 may be used to dispense and apply an adhesive, for example. To this end, the dispensing device 250 may include an adhesive reservoir and an associated source 270 of pressurized air, which source 270 is connected to the dispensing device 250 (and, in particular, the reservoir) to maintain the pressure in the reservoir. The curing device 260 is selected in accordance with the adhesive dispensed and applied by the dispensing device 250. For example, the curing device 260 may include a light source having a wavelength selected in accordance with the adhesive used or a heat source. According to a particular embodiment of the present disclosure, the light source comprises a high intensity UV lamp. The dispensing device 250 and the curing device 260 may each have an electrical connection for power and control.

As indicated in FIG. 4, the method 300 begins at block 302 with the positioning of the core 104 on the worktable 202. The core 104, as illustrated, is an open-celled grid pattern that may be preassembled beforehand of pre-notched subelements designed to fit together in a nested fashion; the subelements need not be attached to each other at this point in the method 300, the attachment to the sheets being sufficient to hold the subelements in place in certain embodiments. It will be further recognized that the core 104 may instead have any of a number of different geometric configurations, such as the exemplary configurations illustrated in FIG. 2. Preferably, the core 104 is disposed on a worktable 202, and positioned using a jig 230 to fix the relative position of the core 104 to the worktable 202. As illustrated, the core 104 has an edge 112 disposed on the worktable 202 and an edge 110 facing the tool holder 204. The edge 112 may be disposed in slots defined by the jig 230 so as to position the core 104 relative to the worktable 202.

According to certain embodiments, once the core 104 is positioned on the worktable 202, the process of attaching the first sheet 102 to the core 104 may begin. In particular, adhesive is applied to the edge 110 of the core 104 using the dispensing device 250 by guided computer numerical control, as indicated in FIG. 4 at block 304. Specifically, the dispensing device 250 is disposed in or mounted to the tool holder 204, which then follows a predetermined pattern over the edge 110 of the core 104 in a plane parallel to the edge 110, such that adhesive is applied only to the edge 110, and not to the remainder of the core 104. It will be recognized that not only does computer numerical control of the movement of the dispensing device 250 facilitate the precise application of the adhesive to the core 104, it also permits the system 200 flexibility to quickly transition from the manufacture of a first façade element with a first core having a first pattern to a second façade element with a second core having a second pattern simply by changing the programming of the tool holder 204 and carriers 206, 208.

The movement of the dispensing device 250 may be dependent upon a number of factors. For example, the rate of flow of the adhesive from the applicator, the viscosity of the adhesive, the width and length of the adhesive bead, the ambient temperature at the time of manufacture all may affect the rate of travel of the dispensing device 250. Other considerations that may affect the rate of travel may include the thickness of the core material, the weight of the sheet, the light transmission characteristics of the sheet material, the type of adhesive used (one part vs. two part (with catalyst), etc.), reservoir levels, air pressure levels, the type of applicator, and the diameter and length of the applicator nozzle. However, it has been determined experimentally that a rate of travel of 1 inch (2.54 cm) per second may produce acceptable results.

However, it will be recognized that the rate of travel is dependent upon a large number of variables. Further, it will also be recognized that the movement of the dispensing device may be varied for a desired rate of production, or with differing core and sheet materials. Thus, it is that each production run may be uniquely configured to account for these variables prior to each panel assembly.

Once the application of adhesive is complete, a first sheet 102 of light-transmitting material is applied to the edge 110 of the core 104, as indicated at block 306 in FIG. 4. This step is also schematically represented in FIG. 3 by a sheet 102 illustrated as being moved in the direction of arrow A to the core 104. According to certain embodiments, the sheet 102 is disposed on top of the core 104 by first being aligned with the core 104 in the X-direction and in the Y-direction using guides 212 so as to be parallel to but spaced from the edge 110, and then lowered onto the edge 110 in the direction of arrow B to a precise location defined by the jig 230.

With the sheet 102 applied to the core 104, the method 300 continues to block 308, wherein the adhesive is cured. In particular, the adhesive is cured along the edge 110 of the core 104 by the curing device 260 using guided computer numerical control to secure the core 104 to the first sheet 102 to define a partial assembly. The controller 220 controls the motion of the curing device 260 (via the tool holder 204 and carriers 206, 208) so that the curing device 260 is directed in a plane parallel to the edge 110 over only those portions of the core 104 as have had adhesive applied thereto, namely the edge 110. This process is facilitated by the fact that the controller 220 has been programmed to move the tool over the core 104 during the adhesive application step, and can now repeat a similar path in the adhesive curing step.

Because the tool holder 204 (and the carriers 206, 208) may be controlled to follow the precise path required to pass over only those sections of the core 104 to which adhesive is applied, high light (or heat) intensity may be maintained on the adhesive, which may result in higher rates of cure for the adhesive, which may have the further consequence of reducing the time required (and thus the cost) to manufacture the element 100. Additionally, because precision of the guidance of the curing device 260, the size of the curing device 260 may be limited to a high intensity focused area, and thus overall energy consumption of the method 300 limited. Furthermore, the fact that a UV light may be used to cure the adhesive is a consequence of the materials selected to fabricate the façade element, with sheets 102, 106 being light-transmitting in nature. Thus, the materials selected for use in the façade element 100 have advantages not only for the use of the element 100 as an architectural design unit, but also for its manufacture.

Once the adhesive has been cured at block 308, the partial assembly is reversed relative to the worktable 202 at block 310. That is, the partial assembly is disposed on the worktable 202 with the first sheet 102 disposed on worktable 202. With the partial assembly in this orientation, blocks 312, 314, and 316 of the method 300 are carried out, which blocks are similar (if not the same as) blocks 304, 306, and 308. In particular, at block 312, adhesive is applied to the edge 112 of the core 104 by the tool holder 204 using guided computer numerical control. Further, a second sheet 106 of light-transmitting material is applied to the edge 112 of the core 104 at block 314. Finally, the adhesive is cured along the edge 112 of the core 104 using guided computer numerical control to secure the core 104 to the second sheet 106 to define a completed assembly, façade element or panel 100.

According to certain embodiments, it may be desired to leave the sides of the element 100 open, as illustrated in certain embodiments in FIG. 2. However, as a further step, a frame may be installed about the edge of the element 100 or the core 104 (see FIG. 1), and the element 100 sealed relative to the environment to prevent air infiltration during use, to avoid energy losses, and to avoid the build up of condensation inside the panel, for example. It is also possible to design an open ventilated element, where a path is left open between adjacent cells of the core 104 and the environment to allow air to pass through the panel to achieve various active performance characteristics. Other alternatives are possible such as including an inert gas or partial evacuation in the open space within the panel volume to further improve on the energy efficiency performance of the façade panel in buildings and the like.

It is believed that the present disclosure may have several benefits, any one or more of which may be present in a particular embodiment according to the present disclosure. For example, as mentioned above, the present system and method permit customized manufacturing of simple or complex core configurations. The customized manufacturing may permit the façade elements to be tailored to a specific building type according to aesthetic choice and performance requirements for exterior and interior applications. Precise application and curing of the UV adhesive may limit the effect of fabrication errors on the façade element's performance characteristics.

Further variants to the system described herein are also possible. For example, while the system described above may use computer numerical control to guide both the adhesive application and the adhesive curing, it may be possible to use the computer numerical control only for the adhesive application. According to such a system, the positioning of the core, the application of the adhesive and the positioning and application of the sheet would occur as described above. However, the curing of the adhesive would instead be performed in an enclosed chamber wherein a generalized heat or light source applies heat or light to the pre-cured assembly without computer numerical control to specifically target the edges 110. Such a general application may be more economically advantageous than the curing guided by computer numerical control in certain circumstances. Of course, there are challenges with the use of generalized application of heat or light, including the time required to achieve the desired result, because the generalized effects of the heat or light on the subassembly or assembly must be considered as well.

What is claimed is:

1. A method for fabricating a façade element, the method comprising:
disposing a core on a worktable, the core having a first edge and a second edge opposite the first edge, the second edge being disposed on the worktable;
applying an adhesive to the first edge of the core using guided computer numerical control;
applying a first sheet of light-transmitting material to the first edge of the core;
curing the adhesive along the first edge of the core using guided computer numerical control to secure the core to the first sheet to define a partial assembly;
disposing the partial assembly on the worktable with the first sheet disposed on worktable;
applying an adhesive to the second edge of the core using guided computer numerical control;
applying a second sheet of light-transmitting material to the second edge of the core;
curing the adhesive along the second edge of the core using guided computer numerical control to secure the core to the second sheet to define a completed assembly.

2. The method according to claim 1, wherein disposing the core on the worktable comprises disposing the core on the worktable in a jig, the jig having slots to receive the second edge of the core.

3. The method according to claim 1, further comprising:
moving an adhesive applicator in a plane parallel to the first edge of the core to apply the adhesive to the first edge of the core.

4. The method according to claim 3, further comprising:
moving a light source or a heat source in a plane parallel to the first edge of the core to cure the adhesive applied to the first edge of the core.

5. The method according to claim 3, further comprising
disposing a second core on a worktable, the second core having a first edge and a second edge opposite the first edge, the second edge being disposed on the worktable,
the core having a first pattern and the second core having a second pattern that is different than the first pattern;
reprogramming a controller according to the second pattern;
applying an adhesive to the first edge of the second core using guided computer numerical control;
applying a first sheet of light-transmitting material to the first edge of the second core;
curing the adhesive along the first edge of the second core using guided computer numerical control to secure the second core to the first sheet to define a partial assembly;
disposing the partial assembly on the worktable with the first sheet disposed on worktable;
applying an adhesive to the second edge of the second core using guided computer numerical control;
applying a second sheet of light-transmitting material to the second edge of the second core;
curing the adhesive along the second edge of the second core using guided computer numerical control to secure the second core to the second sheet to define a completed assembly.

6. The method according to claim 1, wherein the core comprises a plurality of thin-walled subelements, which subelements may define an open-celled grid pattern.

7. The method according to claim 6, further comprising assembling the core prior to disposing the core on the worktable.

8. The method according to claim 7, wherein disposing the core on the worktable comprises disposing the core on the worktable in a jig, the jig having slots to receive the second edge of the core.

9. The method according to claim 1, wherein the core is made of a rigid opaque, translucent or transparent material.

10. The method according to claim 9, wherein the core is made of glass, polycarbonate, acrylic, polypropylene, polyethylene terephthalate, or a fiber composite.

11. The method according to claim 9, wherein the core is colored, tinted or coated.

12. The method according to claim 1, wherein the first and second sheets comprising a plurality of thin sheets.

13. The method according to claim 12, wherein the first and second sheets are made of an opaque, translucent or transparent material.

14. The method according to claim 13, wherein the first and second sheets are made of glass, polycarbonate, acrylic, polypropylene, polyethylene terephthalate or a fiber composite.

15. The method according to claim 13, wherein the first and second sheets are colored, tinted or coated.

16. The method according to claim 1, wherein
applying a first sheet of light-transmitting material to the first edge of the core comprises using a jig guide to precisely locate the first sheet on the core; and
applying a second sheet of light-transmitting material to the second edge of the core comprises using a jig guide to precisely locate the second sheet on the partial assembly.

17. A system for fabricating a façade element, the system comprising:
a worktable;
a tool holder mounted on a first carrier, the first carrier mounted on a second carrier, and the second carrier mounted on rails that run along a length of the worktable,
the first carrier moveable relative to the second carrier in a first direction, the second carrier moveable relative to the worktable in a second direction orthogonal to the first direction, and the tool holder moveable in a third direction orthogonal to the first and second directions;
an adhesive dispenser attached to the tool holder;
a curing device attached to the tool holder; and
a controller programmed:
to control the tool holder, first carrier, second carrier and the adhesive dispenser to apply an adhesive to a first edge of a core, the core disposed on the worktable and having a second edge opposite the first edge,
to control the tool holder, first carrier, second carrier and the curing device to cure the adhesive along the first edge of the core through a first sheet of light-transmitting material applied to the first edge of the core using guided computer numerical control to secure the core to the first sheet to define a partial assembly,
to control the tool holder, first carrier, second carrier and the adhesive dispenser to apply an adhesive to the second edge of the core using guided computer numerical control;
to control the tool holder, first carrier, second carrier and the curing device to cure the adhesive along the second edge of the core through a second sheet of light-transmitting material applied to the second edge of the core using guided computer numerical control to secure the core to the second sheet to define a completed assembly.
